(19) United States
(12) Patent Application Publication
(10) Pub. No.: US 2014/0379130 A1
(43) Pub. Date: Dec. 25, 2014

(54) MOVABLE MEDICAL APPARATUS AND METHOD FOR CONTROLLING MOVEMENT OF THE SAME

(71) Applicant: SAMSUNG ELECTRONICS CO., LTD., Suwon-si (KR)

(72) Inventors: Dong Jae LEE, Hwaseong-si (KR); Woo Sup HAN, Yongin-si (KR); Sang Kyun KANG, Suwon-si (KR); Hyeon Min LEE, Gunpo-si (KR)

(73) Assignee: SAMSUNG ELECTRONICS CO., LTD., Suwon-si (KR)

(21) Appl. No.: 14/293,443

(22) Filed: Jun. 2, 2014

(30) Foreign Application Priority Data
Jun. 24, 2013 (KR) 10-2013-0072229

(51) Int. Cl. G05D 1/02

(52) U.S. Cl. CPC G05D 1/0246
USPC 700/259

(57) ABSTRACT

A movable medical apparatus may include a sensing unit to sense force externally applied to the movable medical apparatus, a control unit to generate one or more control signals to move, rotate, or stop the movable medical apparatus in accordance with the sensed force, and an apparatus moving unit to move, rotate, or stop the movable medical apparatus in accordance with the one or more control signals. A method for controlling movement of the movable medical apparatus may be implemented by the movable medical apparatus by sensing a force externally applied to the movable medical apparatus, generating a control signal based on the sensed force, and controlling movement of the movable medical apparatus based on the generated control signal.

### CROSS-REFERENCE TO RELATED APPLICATIONS

This application claims the benefit of Korean Patent Application No. 10-2013-0072229, filed on Jun. 24, 2013 in the Korean Intellectual Property Office, the disclosure of which is incorporated herein by reference.

### BACKGROUND

1. Field

Embodiments disclosed herein relate to a movable medical apparatus and a method for controlling movement of the same.

2. Description of the Related Art

Generally, a medical apparatus may include a tool, machine or device usable for diagnosis or treatment of an object such as a person or animal. Such a medical apparatus may be used for the purpose of diagnosing a disease or an injury, curing a disease or an injury through a surgical operation or procedure, maintaining the life of a patient, alleviating or treating pain, or taking precautions against pain.

An apparatus for checking the inner parts of a human body or animal in order to diagnose a disease may be embodied by, for example, a radiation imaging apparatus using radiation, an ultrasonic imaging apparatus using ultrasonic waves, a magnetic resonance imaging (MRI) apparatus utilizing magnetic resonance, an endoscope in order to observe inner tissues of an object, and the like. For example, a radiation imaging apparatus may include a general radiation imaging apparatus, a digital radiography apparatus, a mammography apparatus, a computed tomography apparatus, and the like. Meanwhile, a surgical robot is known as an apparatus for treating disease or injury through a surgical operation or procedure.

### SUMMARY

Additional aspects and/or advantages will be set forth in part in the description which follows and, in part, will be apparent from the description, or may be learned by practice of the invention.

Therefore, it is an aspect of the example embodiments disclosed herein to provide a medical apparatus movable in multiple directions in accordance with a user's intention, and a method for controlling the same.

Another aspect of the example embodiments disclosed herein is to provide a medical apparatus having high mobility, and a method for controlling the same.

Another aspect of the example embodiments disclosed herein is to provide a movable medical apparatus and a method for controlling the same in order to eliminate inconvenience occurring during lateral movement of the medical apparatus carried out only through forward and backward driving or rotation.

Still another aspect of the example embodiments disclosed herein is to improve convenience of positioning upon radiation imaging or using a surgical robot.

Additional aspects of the example embodiments disclosed herein will be set forth in part in the description which follows and, in part, will be apparent from the description, or may be learned by practice of the invention.

In accordance with one aspect of the example embodiments disclosed herein, a movable medical apparatus includes a force sensing unit to sense force externally applied to the movable medical apparatus, a control unit to generate one or more control signals to move, rotate, or stop the movable medical apparatus in accordance with the sensed force, and an apparatus moving unit to move, rotate, or stop the movable medical apparatus in accordance with the one or more control signals.

The apparatus moving unit may include a plurality of driven members, and one or more drivers each to drive one or more of the plural driven members in accordance with the one or more control signals in order to move or rotate the medical apparatus.

The control unit may generate one or more control signals for the one or more drivers, respectively, in accordance with the sensed force. In this case, the one or more drivers may drive or stop the one or more driven members connected to the one or more drivers in accordance with the one or more control signals for the one or more drivers, respectively.

The one or more control signals may include a control signal for at least one of a rotation direction of each of the plural driven members and a rotational speed of each of the plural driven members.

Each of the drivers drives one or more of the driven members.

Each of the driven members may include a mecanum wheel formed with a plurality of rotation rollers at an outer circumferential surface of the mecanum wheel.

The apparatus moving unit may include a plurality of driven members, one or more drivers each to drive one or more of the plural driven members in accordance with the one or more control signals, and a steering unit to steer the plural driven members.

The steering unit may include rotation shaft members each coupled, at one end thereof, with an associated one of the driven members or an associated one of the drivers, and steering drivers to rotate the rotation shaft members, respectively, in accordance with the one or more control signals.

The control unit may generate control signals for the drivers or the steering drivers in accordance with the externally applied force.

The force sensing unit may output an electrical signal corresponding to the externally applied force. In this case, the control unit may receive the electrical signal from the force sensing unit, may generate one or more control signals corresponding to the electrical signal, and may transmit the one or more control signals to the apparatus moving unit.

The movable medical apparatus may further include a grip member to transmit the externally applied force to the force sensing unit. In this case, the grip member may be directly installed at the force sensing unit, to transmit force externally applied thereto to the force sensing unit.

The grip member may not be installed at the force sensing unit. In this case, the movable medical apparatus may further include a force transmitter to transmit, to the force sensing unit, the force applied to the grip member.

In accordance with another aspect of the example embodiments disclosed herein, a movable medical apparatus includes a motion sensing unit to sense external motion, a control unit to generate one or more control signals to move, rotate, or stop the movable medical apparatus in accordance with the sensed motion, and an apparatus moving unit to move, rotate, or stop the movable medical apparatus in accordance with the one or more control signals.

The apparatus moving unit may include a plurality of driven members, and one or more drivers each to drive one or more of the plural driven members connected to the one or more derivers in accordance with the one or more control signals in order to move or rotate the medical apparatus.

The control unit may generate one or more control signals for the one or more drivers, respectively, in accordance with the sensed motion.

The one or more drivers may drive or stop the one or more driven members connected to the one or more drivers in accordance with the one or more control signals for the one or more drivers, respectively.

The one or more control signals may include a control signal for at least one of a rotation direction of each of the plural driven members and a rotational speed of each of the plural driven members.

Each of the drivers may drive one or more of the driven members.

Each of the driven members may include a mecanum wheel formed with a plurality of rotation rollers at an outer circumferential surface of the mecanum wheel.

The apparatus moving unit may include a plurality of driven members, one or more drivers each to drive one or more of the plural driven members in accordance with the one or more control signals, and a steering unit to steer the plural driven members. The steering unit may include rotation shaft members each coupled, at one end thereof, with an associated one of the driven members or an associated one of the drivers, and steering drivers to rotate the rotation shaft members, respectively, in accordance with the one or more control signals. In this case, the control unit may generate control signals for the drivers or the steering drivers in accordance with the sensed motion.

The motion sensing unit may sense the external motion, using at least one of infrared light, ultrasonic waves, electromagnetic waves, and visible light.

In accordance with another aspect of the example embodiments disclosed herein, a movable medical apparatus includes a sensing unit to sense an object to be sensed, and one or more rotating members to be rotated or stopped in an individual manner in accordance with operation of the sensed object in order to move, rotate, or stop the movable medical apparatus in a predetermined direction.

The one or more rotating members may be adjusted in rotational speed and rotation direction in accordance with manipulation of a user.

The sensing unit may include a force sensor to sense force externally applied to the movable medical apparatus or a motion sensor to sense operation of the object.

In accordance with another aspect of the example embodiments disclosed herein, a method for controlling movement of a movable medical apparatus, using at least one moving unit includes sensing force externally applied to the movable medical apparatus, measuring a magnitude of the sensed force and a direction of the sensed force, determining operation of the movable medical apparatus in accordance with the measured force magnitude and direction, and controlling the at least one moving unit in accordance with the determined operation of the movable medical apparatus, thereby moving or rotating the movable medical apparatus.

The at least one moving unit may include a plurality of mecanum wheels each formed with a plurality of rotation rollers at an outer circumferential surface of the mecanum wheel. The moving or rotating the movable medical apparatus may include adjusting at least one of a rotation direction of each of the plural mecanum wheels a rotational speed of each of the plural mecanum wheels to more or rotate the movable medical apparatus.

The at least one moving unit may include a plurality of driven members, one or more drivers each to drive one or more of the plural driven members in accordance with one or more control signals, and a steering unit to steer the plural driven members. In this case, the moving or rotating the movable medical apparatus may include adjusting at least one of a rotation direction of each of the driven members and a rotational speed of each of the driven members to more or rotate the movable medical apparatus.

In accordance with another aspect of the example embodiments disclosed herein, a method for controlling movement of a movable medical apparatus, using at least one moving unit includes sensing motion, measuring at least one of a direction of the sensed motion, a magnitude of the sensed motion, and a speed of the sensed motion, determining operation of the movable medical apparatus in accordance with the measured motion direction, magnitude, and speed, and controlling the at least one moving unit in accordance with the determined operation of the movable medical apparatus, thereby moving or rotating the movable medical apparatus.

In accordance with another aspect of the example embodiments disclosed herein, medical apparatus may include a body including a rotating member attached to the body, a first sensing unit to sense an external force applied to the medical apparatus, a second sensing unit to sense a motion of an object disposed external to the medical apparatus, a controller to determine an operation of the medical apparatus based on at least one of a sensed external force and a sensed motion of an object disposed external to the medical apparatus, and an apparatus moving unit to move the medical apparatus based on the determined operation.

The first sensing unit may include a pressing member to receive the applied external force, a measuring member coupled to the pressing member to measure at least one of a magnitude and a direction of the applied external force, and to output an electrical signal based on the measured magnitude and direction of the applied external force, and an amplifier to selectively amplify the electric signal.

The second sensing unit may sense the motion of the object by receiving light reflected from the object or by emitting ultrasonic waves or electromagnetic waves toward the object and receiving ultrasonic waves or electromagnetic waves reflected from the object, and the second sensing unit may output an electrical signal corresponding to the received light, ultrasonic waves, or electromagnetic waves. The medical apparatus may further include a motion determiner to determine at least one of a magnitude, direction, and speed of the motion of the object based on the electrical signal.

The rotating member may correspond to a mecanum wheel and the apparatus moving unit may include a driver to drive the mecanum wheel and a steering unit to drive the driver. The steering unit may include a rotating shaft member connected at a first end to the driver or the mecanum wheel and a steering driver coupled to a second end of the rotating shaft member to rotate the rotating shaft member based on the determined operation, to cause the medical apparatus to move in a direction corresponding to at least one of the applied external force and the sensed motion of the object.

### BRIEF DESCRIPTION OF THE DRAWINGS

Reference will now be made in detail to the example embodiments disclosed herein, examples of which are illustrated in the accompanying drawings.

FIG. 1 is a block diagram explaining an embodiment of a movable medical apparatus;

FIG. 2 is a block diagram illustrating a configuration of the movable medical apparatus according to an embodiment;

FIGS. 3A and 3B illustrate, through a perspective view and a plan view, a configuration of the movable medical apparatus according to an embodiment;

FIGS. 4A and 4B are views explaining an embodiment of a force sensing unit;

FIG. 5 is a view explaining operation of the movable medical apparatus;

FIG. 6 is a perspective view illustrating an embodiment of the force sensing unit;

FIG. 7 is a view illustrating an embodiment of the movable medical apparatus, to which the force sensing unit is attached;

FIG. 8 is a view illustrating a configuration of an embodiment of the movable medical apparatus;

FIG. 9 is a view explaining a method for determining motion of the user, based on received visible light;

FIG. 10 is a block diagram explaining an embodiment of the apparatus moving unit of the movable medical apparatus

FIGS. 11 and 12 are plan and side views of a mecanum wheel;

FIGS. 13A to 13F are views illustrating examples of movement control of the movable medical apparatus using the mecanum wheels;

FIG. 14 is a block diagram explaining another embodiment of the apparatus moving unit of the movable medical apparatus;

FIG. 15 is a view explaining an example of the steering unit included in the apparatus moving unit;

FIGS. 16A to 16D are views illustrating control of movement of the movable medical apparatus, which includes steering units; and

FIGS. 17 and 18 are flowcharts illustrating embodiments of a method for controlling movement of the movable medical apparatus, respectively.

### DETAILED DESCRIPTION

Reference will now be made in detail to the example embodiments of the disclosure, examples of which are illustrated in the accompanying drawings, wherein like reference numerals refer to like elements throughout.

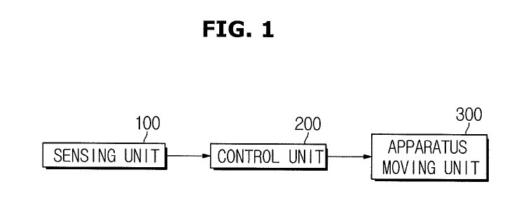

FIG. 1 is a block diagram explaining an embodiment of a movable medical apparatus.

Referring to FIG. 1, in accordance with the illustrated embodiment, the movable medical apparatus may include a sensing unit 100, a control unit 200, and an apparatus moving unit 300.

The sensing unit 100 may sense an object to be sensed, in response to a user's action. The sensing unit 100 may generate an electrical signal corresponding to the sensed object, and may output the generated electrical signal in order to transmit the electrical signal to the control unit 200. The sensing unit may include one or more sensors, for example.

For example, the sensing unit 100 may include a force sensing unit, which senses force or moment (hereinafter, it is assumed that force includes moment unless there is no particular mention otherwise) externally applied thereto. The sensing unit 100 may output an electrical signal corresponding to the sensed force. The user may take an action to, for example, press, deform, or rotate the sensing unit 100 or a manipulation device physically or electrically connected to the sensing unit 100. The sensing unit 100 may sense external force applied thereto when the user takes an action to, for example, press, deform, or rotate the sensing unit 100, and may then generate at least one electrical signal corresponding to the sensed external force.

Alternatively, or additionally, the sensing unit 100 may include a motion sensing unit to sense external movement. In this case, the object to be sensed may be movement of an external object. In this case, the sensing unit 100 may sense movement of an external object, using visible light, infrared light, ultrasonic waves, electromagnetic waves, or the like, reflected from the external object or generated and emitted from the external object. The sensing unit 100 may also sense movement of an external object using heat generated by the external object. Movement of the external object may include a certain gesture or motion taken by the user within a sensing range of the sensing unit 100, for example.

Generally, the sensing unit 100 may sense one or more objects capable of being sensed by the sensing unit 100 in accordance with various types of sensors which may be provided in the sensing unit 100. That is, the disclosure is not limited to the force sensing unit or motion sensing unit disclosed above, and other types of sensors may be utilized by the sensing unit 100.

The sensing unit 100 may be installed inside (internally) or outside (externally) of the movable medical apparatus. When the sensing unit 100 is installed inside of the movable medical apparatus, a separate auxiliary device, for example, a pressing member, may be installed outside of the medical apparatus in order to allow the sensing unit 100 to sense an object in response to a user's action.

The control unit 200 may generate a control command, based on an electrical signal received from the sensing unit 100, and may transmit the generated control command to the apparatus moving unit 300. In detail, the control unit 200 may identify a user's intention, based on the electrical signal received from the sensing unit 100, and may determine a desired operation of the movable medical apparatus in accordance with the identified user's intention. Thereafter, the control unit 200 may generate at least one control command, based on the determined operation of the medical apparatus, and may transmit the generated control command to the apparatus moving unit 300. For example, the control unit may include one or more processors.

For example, the apparatus moving unit 300 may move or rotate the movable medical apparatus in a desired direction or may stop the movable medical apparatus.

In detail, the apparatus moving unit 300 may include at least one rotating member such as a drive wheel. The apparatus moving unit 300 may move or rotate the movable medical apparatus by rotating the at least one rotating member in accordance with the control command from the control unit 200. When the apparatus moving unit 300 includes a plurality of rotating members, each of the rotating members may independently rotate or stop to move or rotate the movable medical apparatus in a desired direction or to stop the movable medical apparatus.

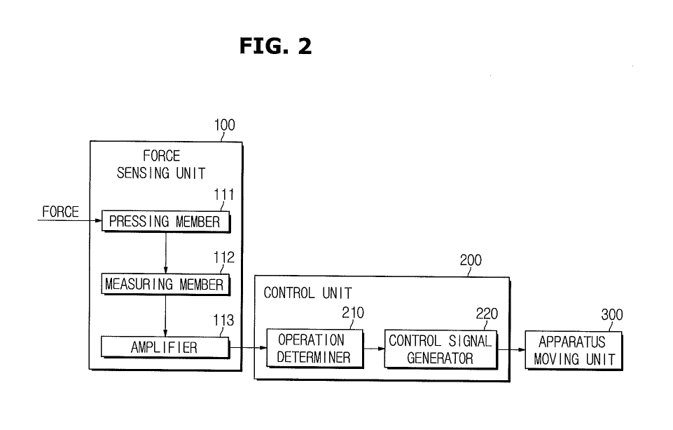

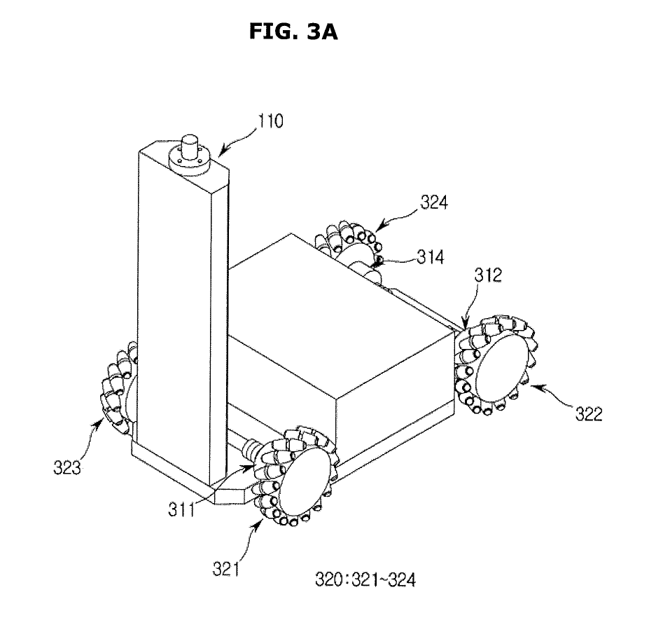

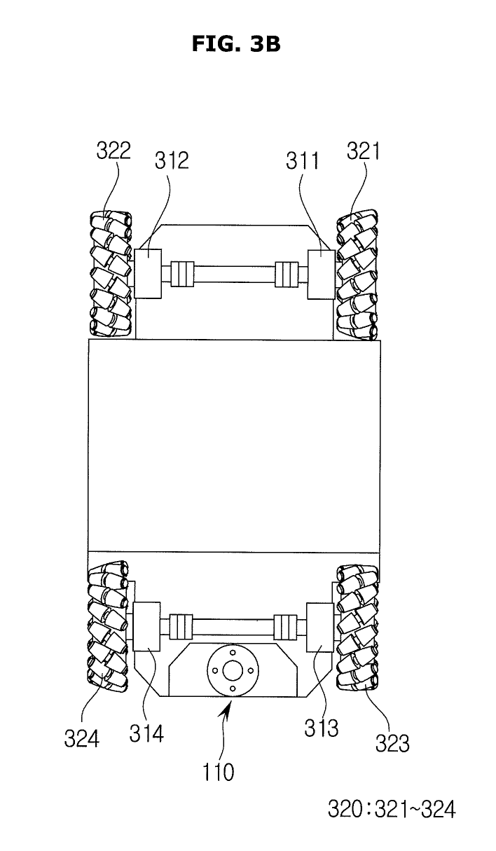

FIG. 2 is a block diagram illustrating a configuration of the movable medical apparatus according to an example embodiment. FIGS. 3A and 3B illustrate, through a perspective view and a plan view, a configuration of the movable medical apparatus according to an example embodiment.

As illustrated in FIGS. 2 to 3B, the sensing unit 100 may include a force sensing unit 110.

The force sensing unit 110 may sense at least one of an external force and an external moment applied thereto, and may output an electrical signal corresponding to the sensed external force and/or external moment. The control unit 200 may generate a control signal, based on, for example, the sensed force and/or external moment, and may control the apparatus moving unit 300 in accordance with the control signal.

The force sensing unit 110 may sense an external force and/or external moment applied thereto, based on a deformation of an elastic member. In detail, the force sensing unit 110 may measure the strain of the elastic member, via a mechanical, optical, or electrical method, thereby sensing force and/or torque externally applied to the force sensing unit 110. The force sensing unit 110 may also sense force and/or torque externally applied thereto, based on piezoelectric or magnetostrictive effects caused by the elastic strain. The force sensing unit 110 may also sense force and/or torque externally applied thereto, based on variation in an oscillation frequency caused by the elastic strain.

As illustrated in FIG. 3A, the force sensing unit 110 may be installed at a predetermined level from the ground in order to allow the user to easily press the force sensing unit 110. For example, the predetermined level may correspond to a height at which the average human may easily or conveniently press the force sensing unit 110. Alternatively, the force sensing unit 110 may be disposed on a body which is adjustable (e.g., a body which may be raised or lowered to set the force sensing unit at a convenient height for a user). Alternatively, or additionally, as illustrated in FIG. 3B, a force sensing unit 110 may be installed at an end of the movable medical apparatus. Of course, the installation position of the force sensing unit 110 is not limited to the positions illustrated in the drawings. The force sensing unit 110 may be installed at various positions of the movable medical apparatus in accordance with a determination of the designer or manufacturer or design or manufacture conditions. For example, the force sensing unit 110 may be installed at a level almost equal to the level of a lower portion of the movable medical apparatus, for example, an axis of a rotating member. In FIG. 3B, the rotating member is generally designated by reference numeral “320” and may include or more of the rotating members 321 through 324 for example. Alternatively, or additionally, a force sensing unit 110 may be installed at a central portion or side surface of the medical apparatus.

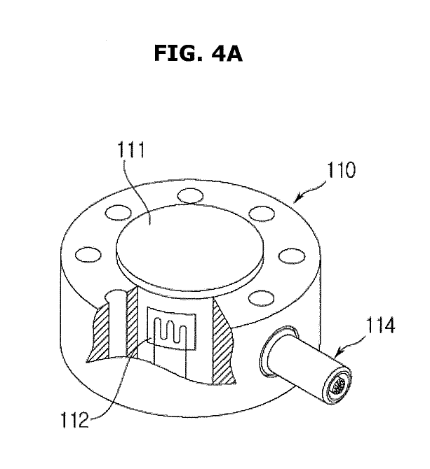

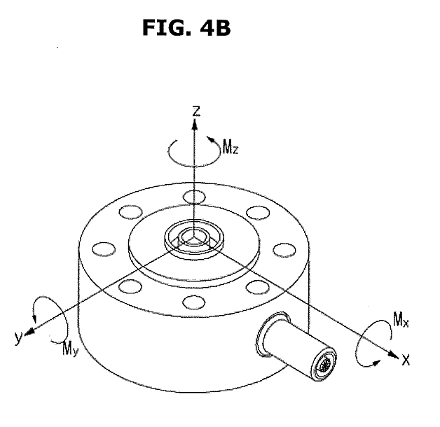

FIG. 4A is a view explaining an example embodiment of the force sensing unit.

In accordance with the illustrated embodiment, as illustrated in FIGS. 2 and 4A, the force sensing unit 110 may include a pressing member 111, to which an external pressing force is applied, and a measuring member 112 to measure the applied pressing force, and to output an electrical signal corresponding to the measured force.

When an external force having a certain magnitude and a certain direction is applied to the pressing member 111, the pressing member 111 may be deformed in accordance with the magnitude and direction of the external force. When a certain torque is applied to the pressing member 111, the pressing member 111 may be twisted. As illustrated in FIG. 4A, the pressing member 111 may have a cylindrical shape. Of course, the shape of the pressing member 111 is not limited to the shape of FIG. 4A, and may include other geometrical shapes. That is, the pressing member 111 may have various shapes, so long as the pressing member 111 senses an external force applied thereto.

The measuring member 112 may output a certain electrical signal in accordance with deformation of the pressing member 111, for example, compression, bending or twisting of the pressing member 111.

In the case of FIG. 4A, the measuring member 112 may be, for example, a strain gauge. For example, the strain gauge may exhibit variation in electrical resistance in accordance with the strain of the pressing member 111, and may output an electrical signal in the form of voltage or current in accordance with the electrical resistance variation.

As illustrated in FIG. 4A, the measuring member 112, which may be a strain gauge, as described above, may be formed at a side surface of the pressing member 111. Of course, embodiments of the disclosure are not limited to such a configuration. The measuring member 112 may be installed at any position, so long as the measuring member 112 may appropriately measure deformation of the pressing member 111 in accordance with the kind of deformation of the pressing member 111 at the installed position. For example, the measuring member 112 may be disposed on an upper or lower surface of the pressing member 111, or may be internal to the pressing member 111.

One or more measuring members 112 may be provided at the force sensing unit 110. For example, a plurality of measuring members 112 may be formed at the side surface of the pressing member 111. When a plurality of measuring members 112 is coupled to the pressing member 111, the force sensing unit 110 may acquire an increased amount of information about deformation of the pressing member 111.

The electrical signal output from the measuring member 112 may be transmitted to the control unit 200 via a connecting terminal 114 and a separate cable or various circuits.

Meanwhile, as illustrated in FIG. 2, the force sensing unit 110 may further include an amplifier 113 to amplify an electrical signal output from the measuring member 112, if necessary. For example, when the electrical signal output from the measuring member 112 is weak, the amplifier 113 amplifies the weak electrical signal, to enable the control unit 200 to appropriately determine a desired operation of the movable medical apparatus.

FIG. 4B is a view explaining the direction of a force which may be applied to the force sensing unit and a rotation direction of a torque which may be applied to the force sensing unit.

As illustrated in FIG. 4B, the force sensing unit 110 may include a 6-axis force/moment sensor. The 6-axis force/moment sensor may measure a magnitude and a direction of a force in a space, on the basis of three axes x, y, and z, while measuring a rotation of a force, namely, a magnitude and a direction of a moment, on the basis of another three axes Mx, My, and Mz. The force sensing unit 110 may sense a 3-axis force and a 3-axis moment in accordance with a force or moment applied to the force sensing unit 110 and, as such, may generate an electrical signal. However, the disclosure is not limited to the above-provided example force/moment sensors. For example, the force and/or moment sensors may sense a force and/or moment on the basis of less than or more than three axes.

For convenience of description, it is assumed that the three axes representing spatial direction of force cross perpendicularly, and two of the three axes are disposed on the same plane. It is also assumed that the three axes associated with moment rotate about the x, y, and z-axes, respectively.

When a force is applied to the pressing member 111 of the force sensing unit 110 in a certain direction, the pressing member 111 may be deformed in accordance with the application direction and a magnitude of the force, as described above.

For example, when the user applies a force in an x-axis direction in FIG. 4B, a side surface portion of the pressing member 111 in an x-axis direction may be shrunk (compressed or deformed inwardly), whereas a side surface portion of the pressing member 111 in a direction opposite to the x-axis direction, namely, a negative (−) x-axis direction, may be stretched (expanded or deformed outwardly). For example, the pressing member 111 may be more greatly deformed as the force applied by the user increases. The measuring member 112, which may be a strain gauge, senses shrinkage and stretch of the pressing member 111 and degrees thereof, and outputs, to the outside, an electrical signal corresponding to such deformation of the pressing member 112. Similarly, when the user applies a certain magnitude of torque in an Mz-axis direction to the pressing member 111, the pressing member 111 may be twisted and, as such, the measuring member 112 may sense torsion of the pressing member 111, and outputs, to the outside, an electrical signal corresponding to the sensed torsion.

Thus, it may be possible to measure the magnitude and direction of a force applied by the user and the magnitude and direction of a torque applied by the user. When such a force and torque are simultaneously applied to the force sensing unit 110, the force sensing unit 110 may simultaneously sense the force and torque.

In an example embodiment, the force sensing unit 110 may include a force/moment sensor, which senses force and moment externally applied thereto on the basis of a greater or smaller number of axes than 6. For example, the force sensing unit 110 may be a 3-axis force/moment sensor to sense horizontal force, for example, force Fx in an x-axis direction and force Fy in a y-axis direction, and moment in a horizontal rotation direction, for example, moment Mz. However, as mentioned above the disclosure is not so limited and other configurations and axis combinations to sense a force and/or moment are possible.

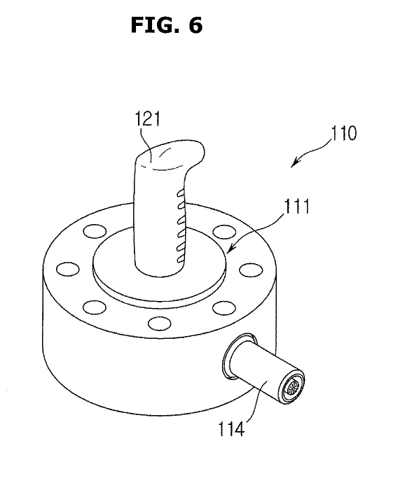

FIG. 6 is a perspective view illustrating an example embodiment of the force sensing unit.

In accordance with the illustrated embodiment, the force sensing unit 110 may include a grip member 121 to transmit, to the force sensing unit 110, force applied thereto from the outside. As illustrated in FIG. 6, the grip member 121 may be directly attached to the pressing member 111 of the force sensing unit 110. The grip member 121 may be moved (e.g., grasped) by the user. The user may apply a certain magnitude of force or moment to the grasped grip member 121. The force or moment applied to the grip member 121 by the user may be transmitted to the pressing member 111 and, as such, the transmitted force may be measured by the measuring member 112. If necessary, the grip member 121 may be formed with certain frictional lugs or finger seating grooves, for convenient grasping.

When the grip member 121 is provided at the force sensing unit 110, as described above, the grip member 121 may be disposed to protrude outwardly of the movable medical apparatus. In an example embodiment, both the grip member 121 and the force sensing unit 110 may be disposed to protrude outwardly of the movable medical apparatus. The user may manipulate the medical apparatus by applying a certain force or moment to the grip member 121 while grasping the grip member 121 disposed at the outside of the medical apparatus.

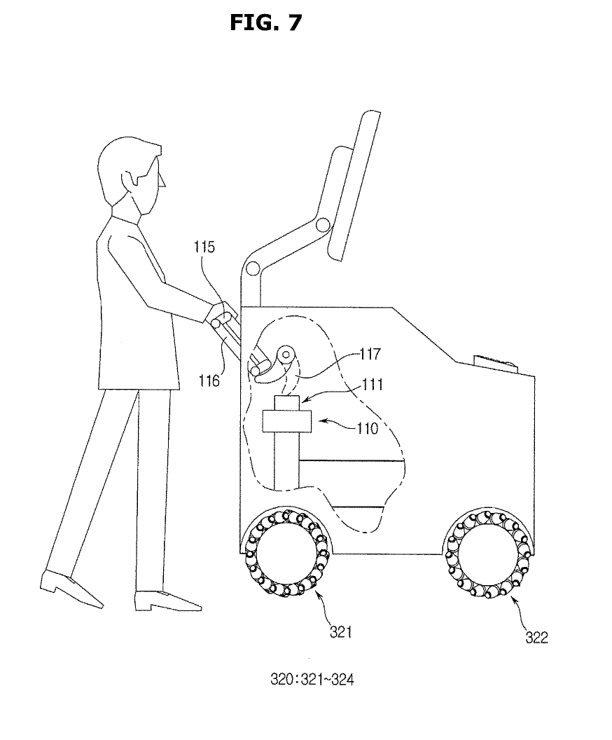

FIG. 7 is a view illustrating an example embodiment of the movable medical apparatus, to which the force sensing unit is attached.

As illustrated in FIG. 7, the force sensing unit 110 may be installed inside of the medical apparatus. For example, it may be impossible for the user to manipulate the medical apparatus, using a grip member 115, when the grip member 115 is directly installed at (or directly attached to) the force sensing unit 110. To this end, a force transmitter 116-117 may be arranged between the grip member 115 and the force sensing unit 110.

In the example embodiment illustrated in FIG. 7, the force transmitter 116-117 may include a first force transmission member 116 and a second force transmission member 117.

The first force transmission member 116 may be coupled to the grip member 115. The first force transmission member 116 may transmit, to the second force transmission member 117, a force or moment applied to the grip member 115 by the user while supporting the grip member 115. In detail, the first force transmission member 116 may be moved in accordance with a force or moment applied to the grip member 115 by the user.

The second force transmission member 117 may transmit, to the force sensing unit 110, a force applied to the grip member 115 by the user while rotating about a certain axis in accordance with movement of the first force transmission member 116. In this case, the second force transmission member 117 applies a certain force to the pressing member 111 of the force sensing unit 110 in accordance with the force applied to the grip member 115 by the user and, as such, the force sensing unit 110 may sense the force applied by the user.

Of course, in another embodiment, in place of the second force transmission member 117, the first force transmission member 116 may directly press the pressing member 111 of the force sensing unit 110.

Although the embodiment, in which the user transmits force to the force sensing unit 110 via the grip member 121 or 115, has been described, the user may apply force or moment to the force sensing unit 110, using a device other than the above-described system, in accordance with another embodiment. Alternatively, the user may directly apply force or moment to the force sensing unit 110 without using a separate device. In this case, a portion or all portions of the force sensing unit 110 may be installed outside of the medical apparatus or at a position which a user is capable of imparting a force or moment upon the force sensing unit 110.

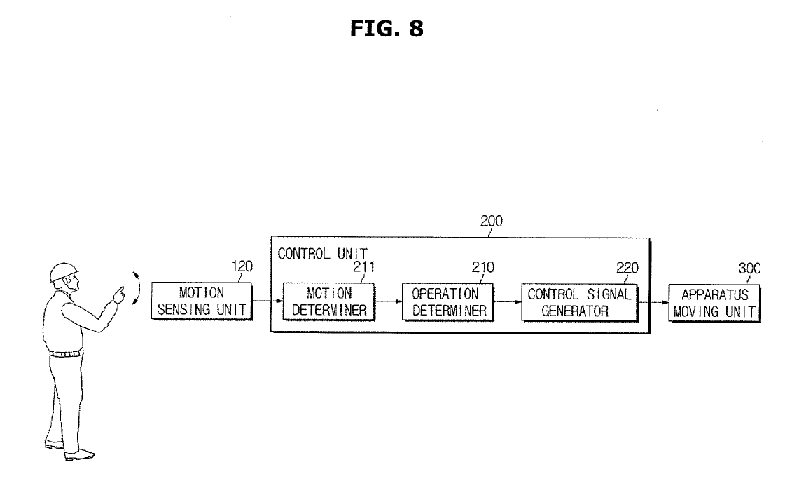

The control unit 200 may receive an electrical signal output from the measuring member 112 or amplifier 113 and, as such, may control an operation of the movable medical apparatus. In detail, as illustrated in FIG. 8, the control unit 200 may include an operation determiner 210 and a control signal generator 220.

The operation determiner 210 may determine a desired operation of the movable medical apparatus, based on an electrical signal received by the operation determiner 210. In an example embodiment, the operation determiner 210 may determine the direction and magnitude of at least one of force and moment, based on the received electrical signal, and may then determine movement, rotation, etc. of the movable medical apparatus in accordance with the determined direction and magnitude.

For example, the operation determiner 210 may determine whether the medical apparatus should move or rotate, based on whether or not the force sensing unit 110 senses a force or moment. That is, when the force sensing unit 110 senses a force or moment, the operation determiner 210 may perform a control operation to cause the medical apparatus to initiate movement or rotation. In addition, the operation determiner 210 may determine a desired movement or rotation direction of the medical apparatus in accordance with the direction of the force or moment sensed by the force sensing unit 110. In accordance with the magnitude of the force or moment sensed by the force sensing unit 110, the operation determiner 210 may also determine a desired movement or rotational speed of the medical apparatus.

FIG. 7 is a view explaining operation of the movable medical apparatus.

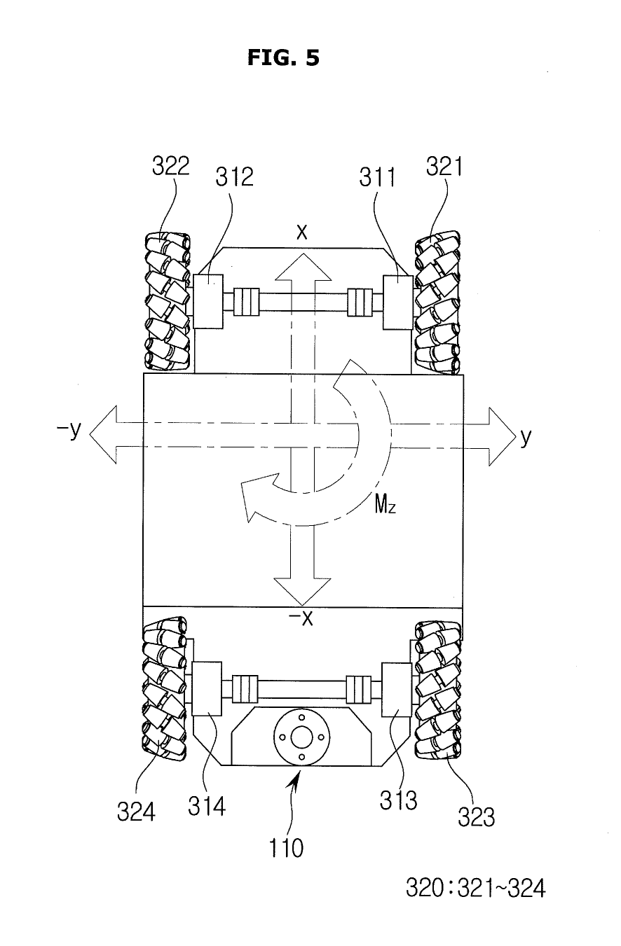

In detail, for example, when the user applies a certain magnitude of force in an x-axis direction to the force sensing unit 110, the operation determiner 210 may determine an operation to move the medical apparatus in a direction corresponding to the direction of force applied by the user, namely, the x-axis direction in FIG. 5. On the other hand, when the user applies a certain magnitude of force in an opposite direction, namely, a negative (−) x-axis direction, to the force sensing unit 110, the operation determiner 210 may determine an operation to move the medical apparatus in the negative (−) x-axis direction in FIG. 5. In an alternative embodiment, the medical apparatus may move in a direction opposite to the direction of force and/or moment applied to the force sensing unit 110, according to a user setting, for example.

Similarly, when the user applies a certain magnitude of force in a y-axis or negative y-axis direction to the force sensing unit 110, the operation determiner 210 may determine an operation to move the medical apparatus in a direction corresponding to the direction of force applied by the user, namely, the y-axis or negative (−) y-axis direction in FIG. 5.

Meanwhile, when the user applies rotational moment Mz to the force sensing unit 110, the operation determiner 210 may determine an operation to rotate the medical apparatus in the Mz direction in FIG. 5 in accordance with the rotational moment Mz.

In an example embodiment, the operation determiner 210 may determine an operation of the movable medical apparatus, based on all components of force sensed by the force sensing unit 110, for example, x to z-axis force components Fx, Fy, and Fz and all moment components Mx, My, and Mz. In another example embodiment, the operation determiner 210 may determine operation of the movable medical apparatus, based on a part of components of force and/or a part of components of moment, sensed by the force sensing unit 110. For example, the operation determiner 210 may determine operation of the movable medical apparatus, based on a part of components of force sensed by the force sensing unit 110, for example, force components Fx and Fy, and a moment component Mz.

The control signal generator 220 may generate a control signal, based on the determined results of the operation determiner 210, and may transmit the control signal to the apparatus moving unit 300.

When the apparatus moving unit 300 includes a plurality of drivers 311 to 314, as illustrated in FIGS. 3A and 3B, the control signal generator may generate control signals for respective drivers 311 to 314, and may transmit the control signals to corresponding ones of the drivers 311 to 314, respectively.

For example, a part of the control signals generated from the control signal generator 220 in association with respective drivers 311 to 314 may be identical, whereas the remaining control signals may be different. The drivers 311 to 314 may be driven in accordance with the control signals transmitted thereto, respectively.

FIG. 8 is a view illustrating a configuration of an example embodiment of the movable medical apparatus.

The sensing unit 100 illustrated in FIG. 1 may include a motion sensing unit 120 as shown in FIG. 8.

The motion sensing unit 120 may sense external motion, and may output at least one electrical signal corresponding to the sensed motion. The electrical signal may be transmitted to the control unit 200.

The motion sensing unit 120 may sense an external motion, using at least one of visible light, infrared light, ultrasonic waves, and electromagnetic waves, for example. For example, the motion sensing unit 120 may sense an external motion, using only one of visible light, infrared light, ultrasonic waves, and electromagnetic waves or a combination of at least two of visible light, infrared light, ultrasonic waves, and electromagnetic waves.

For example, the motion sensing unit 120 may receive visible light reflected from an external object. For example, visible light may be reflected from the entire portion of the body of the user or a particular portion of the body of the user, and the motion sensing unit 120 may output an electrical signal corresponding to the received visible light, namely, image data and, as such, the image data may be transmitted to a motion determiner 211 of the control unit 200. Alternatively, the motion sensing unit 120 may sense infrared light emitted from an external object, for example, the entire portion of the body of the user or a particular portion of the body of the user, and may output an electrical signal corresponding to the sensed infrared light. The electrical signal may be transmitted to the motion determiner 211 of the control unit 200. When the motion sensing unit 120 uses visible light or infrared light, it may be unnecessary to emit separate waves for sensing of motion.

Meanwhile, the motion sensing unit 120 may emit ultrasonic waves or electromagnetic waves to an external object, may receive ultrasonic waves or electromagnetic waves reflected from the external object, and then output an electrical signal corresponding to the received ultrasonic waves or electromagnetic waves and, as such, the electrical signal may be transmitted to the motion determiner 211 of the control unit 200.

The motion sensing unit 120 may receive visible light or infrared light multiple times. Alternatively, or additionally, the motion sensing unit 120 may emit and then receive ultrasonic waves or electromagnetic waves multiple times. In either case, the motion sensing unit 120 may output an electrical signal upon receiving visible light or infrared light or upon receiving ultrasonic waves or electromagnetic waves.

The control unit 200 may determine external motion, based on the electrical signal output from the motion sensing unit 120, and may then determine a desired operation in accordance with the determined motion.

In detail, as illustrated in FIG. 8, the control unit 200 may include the motion determiner 211, operation determiner 210, and control signal generator 220, as described above.

The motion determiner 211 may determine an external motion, for example, a motion of the user or generally, a motion of an object, based on an electrical signal output from the motion sensing unit 120. In detail, the motion determiner 211 may measure at least one of the direction, magnitude, and speed of the motion of the user, based on an electrical signal corresponding to the sensed motion.

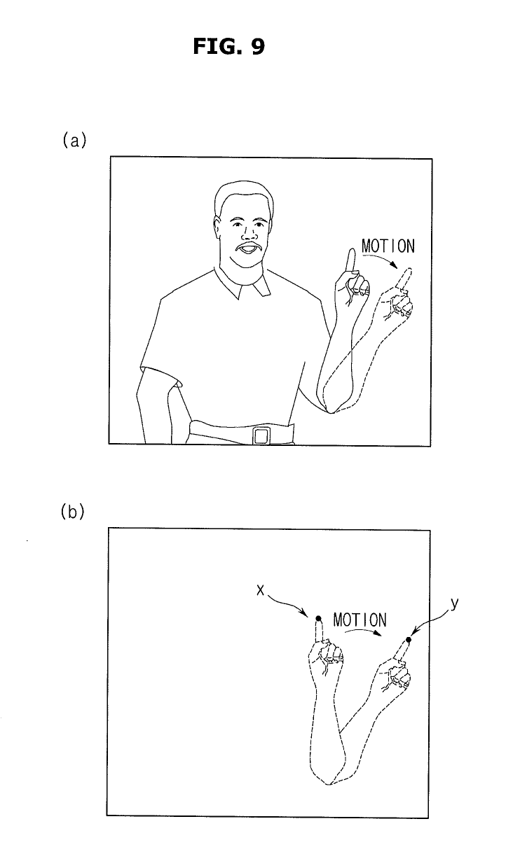

FIG. 9 is a view explaining a method for determining motion of the user, based on received visible light.

The user may make a motion such as a certain gesture within a motion sensing range of the motion sensing unit 120. For example, as illustrated in FIG. 9(a), the user may make a motion of laterally moving one finger. In this case, the motion sensing unit 120 may receive visible light reflected from the entire portion of the body of the user or the finger of the user, and may generate and output an electrical signal, for example, an image signal, corresponding to the received visible light whenever the visible light is received. The motion sensing unit 120 may periodically receive visible light at intervals of a predetermined time, and may then generate and output an image signal. Thus, a plurality of image signals according to motion of the user may be acquired.

Based on a plurality of electrical signals, for example, image signals, output from the motion sensing unit 120, the motion determiner 211 may determine which motion corresponds to the sensed motion. For example, as illustrated in FIG. 9(a), the motion determiner 211 may determine that the user took a gesture of moving the hand and fingers from the left to the right.

For example, the motion determiner 211 may extract a particular point from the image signal, and may determine the direction, speed, etc. of the external motion, based on the extracted particular point. For example, the motion determiner 211 may extract particular points of an image, for example, various portions of the body of the user such as a finger point, a finger boundary, and a hand boundary, may match the particular points among a plurality of images, and may then detect position variation among the matched particular points. As illustrated in FIG. 9(b), the motion determiner 211 may detect image portions exhibiting position variations among the matched particular points in the plural images, for example, the arm, hand, and finger of the user, and, as such, may determine that the user moved the finger point from a first position x to a second position y. In this case, the motion determiner 211 may also determine a movement speed at which the finger point was moved from the first position x to the second position y. In such a manner, the motion determiner 211 may determine the external motion.

Although operation of the motion determiner 211 has been described in conjunction with the example embodiment in which the motion determiner 211 acquires an image signal using visible light, and determines motion through matching of particular points, operation of the motion determiner 211 is not limited to such a method. The motion determiner 211 may determine motion of an external object, for example, a motion of the user, using various motion determination methods usable for motion determination, other than the above-described method.

The operation determiner 210 may determine operation of the movable medical apparatus, based on the determined results of the motion determiner 211. For example, when the user moves their hand in a rightward direction (from the point of view of the motion determiner 211 or a leftward direction from the viewpoint of the user), as illustrated in FIG. 9, the operation determiner 210 may determine that the medical apparatus should be moved to the left or right and, as such, may determine a desired operation to move the medical apparatus to the left or right. In an example embodiment, the operation determiner 210 may determine a desired operation of the movable medical apparatus in accordance with the determined results of the motion determiner 211 while referring to a separate database (not shown) storing information about various operations of the medical apparatus corresponding to various motions. For example, a lookup table may be stored in the database and a specific operation of the movable medical apparatus may be executed based on an association with an external motion identified or determined by the motion determiner. The operation determiner 210 may also determine an appropriate speed at which the movable medical apparatus is operated based on the movement speed of the external object which may be determined by the motion determiner 211. The database may be internal or external to the movable medical apparatus. The database may include a collection of data and supporting data structures which may be stored, for example, in a storage device which may be internal or external to the movable medical apparatus. For example, the storage may be embodied as a storage medium, such as a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof. However, examples of the storage are not limited to the above description, and the storage may be realized by other various devices and structures as would be understood by those skilled in the art.

The control signal generator 220 may generate a control signal in accordance with the determined results of the operation determiner 210, and may transmit the generated control signal to the apparatus moving unit 300.

When the apparatus moving unit 300 includes a plurality of drivers 311 to 314, as illustrated in FIGS. 3A and 3B, the control signal generator may generate control signals for respective drivers 311 to 314, respectively, as described above. For example, the control signals associated with respective drivers 311 to 314 may be identical or different. In addition, a part of the control signals transmitted to respective drivers 311 to 314 may be identical, whereas the remaining control signals may be different.

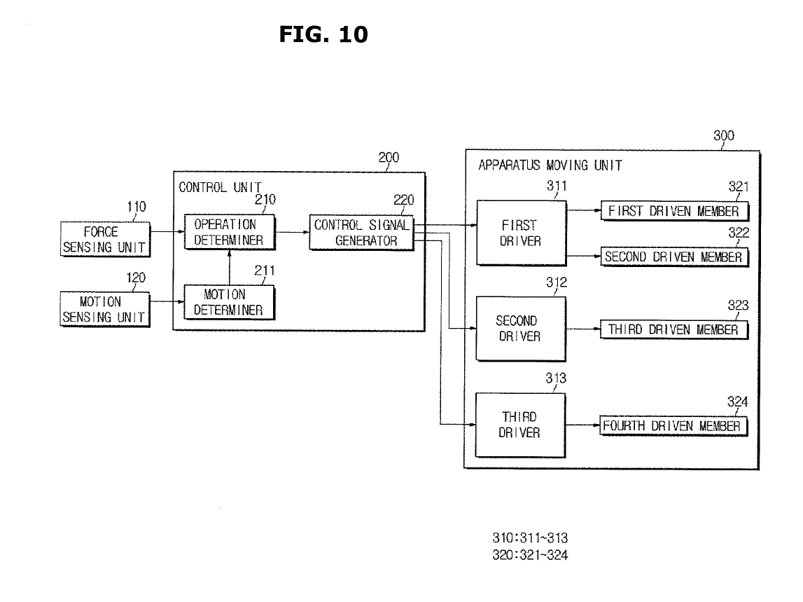

FIG. 10 is a block diagram explaining an example embodiment of the apparatus moving unit of the movable medical apparatus.

The apparatus moving unit 300 may move, rotate or stop the movable medical apparatus in accordance with a control signal transmitted thereto.

In detail, as illustrated in FIG. 10, the apparatus moving unit 300 may include at least one driver 310 and at least one driven member 320 in the illustrated embodiment. As illustrated in FIG. 10, driver 310 may correspond to a plurality of drivers, for example drivers 311 through 313.

The driver 310 operates in accordance with a control signal transmitted from the control unit 200, to drive the driven member 320 in order to move or rotate the movable medical apparatus. When the driven member 320 corresponds to a drive wheel, as illustrated in FIGS. 3A and 3B, the driver 310 may rotate the driven member 320. For example, the driver 310 may rotate the driven member 320 in a certain direction at a certain angular velocity in accordance with a control signal transmitted from the control unit 200. The driver 310 may be one of various kinds of motors.

In an example embodiment, as illustrated in FIG. 10, the apparatus moving unit 300 may include a first driver 311, a second driver 312, and a third driver 313.

The drivers 311 to 313 may simultaneously operate in the same manner in accordance with a single control signal transmitted from the control unit 200. Alternatively, the drivers 311 to 313 may independently operate in accordance with control signals transmitted from the control unit 200, respectively. For example, the drivers 311 to 313 may operate in different manners, respectively. Alternatively, a part of the drivers 311 to 313 may operate in the same manner, whereas the remainder of the drivers 311 to 313 may operate in different manners, respectively.

In an example embodiment, one driver, for example, the first driver 311, may drive a plurality of driven members, for example, first and second driven members 321 and 322. For example, the first driver 311 may drive the first and second driven members 321 and 322 in the same manner. For example, when the first and second driven members 321 and 322 are drive wheels, the first driver 311 may rotate the first and second driven members 321 and 322 in the same direction at the same velocity.

As shown in the example embodiment of FIG. 10, a part of the plural drivers 311 to 313, for example, the first driver 311, drives a plurality of driven members, for example, the first and second driven members 321 and 322, whereas the remainder of the drivers 311 to 313, for example, the second and third drivers 312 and 313, may drive the remaining driven members, for example, the third and fourth driven members 323 and 324, respectively.

The driven member 320 may move or rotate the movable medical apparatus while rotating in accordance with operation of the driver 310.

In an example embodiment, as illustrated in FIGS. 3A and 3B, the driven member 320 may correspond to a mecanum wheel.

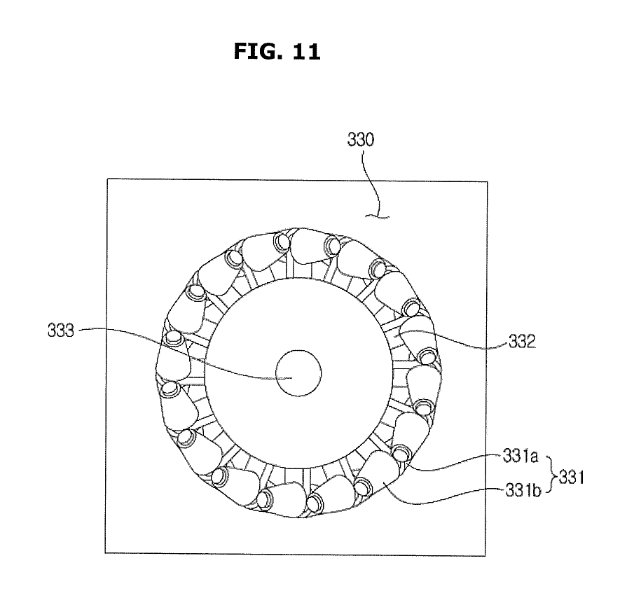

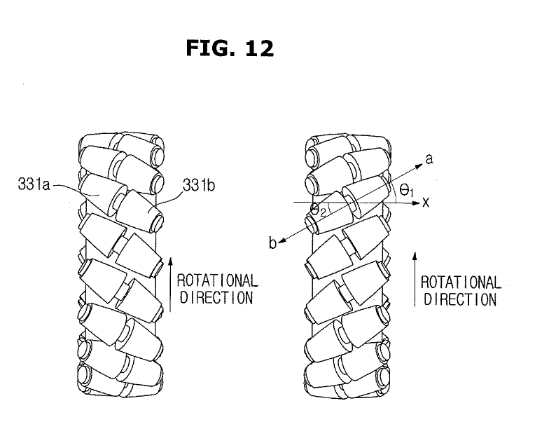

FIGS. 11 and 12 are plan and side views of a mecanum wheel.

As illustrated in FIG. 11, the mecanum wheel, which is designated by reference numeral “330”, may be formed with a plurality of rotation rollers 331 at an outer circumferential surface of a cylindrical or circular plate 333.

As illustrated in FIGS. 11 and 12, each rotation roller 331 may include a plurality of roller members 331a and 331b. Each of the roller members 331a and 331b may have a truncated conical shape. That is, when each of the roller members 331a and 331b is cross-sectioned in a direction perpendicular to the bottom thereof, it may have a trapezoidal shape. Each of the roller members 331a and 331b may have a smaller plane area at one end thereof than at the other end thereof.

Here, each extension direction of the roller members 331a and 331b is defined as a direction away from the roller member end having a smaller plane area while being perpendicular to the roller member end. As illustrated in FIG. 12, the extension directions of the roller members 331a and 331b, namely, directions a and b, may be inclined by angles θ₁ and θ₂ with respect to a direction (“x” in FIG. 12) perpendicular to the outer circumferential surface of the cylindrical or circular plate 333, respectively. For example, the angles θ₁ and θ₂ may be equal or different. For example angles θ₁ and θ₂ of the roller members 331a and 331b may be about 45°.

Since the roller members 331a and 331b are inclined with respect to the outer circumferential surface of the cylindrical or circular plate 333, the rotation rollers 311 may also be installed at the outer circumferential surface of the cylindrical or circular plate 333 while forming a certain angle with respect to the direction x perpendicular to the cylindrical or circular plate 333.

The plural rotation rollers 331 may be coupled to a plurality of support members 332 at one-side ends of the support members 332, respectively. The other one-side ends of each support member 332 may be attached to the outer circumferential surface of the cylindrical or circular plate 333.

The cylindrical or circular plate 333 may be rotated by the driver 310 associated therewith.

When the cylindrical or circular plate 333 is rotated by the driver 310, the plural rotation rollers 331 may also be rotated in accordance with a rotation direction of the cylindrical or circular plate 333. In this case, it may be possible to move the medical apparatus in various directions by adjusting rotational speeds or directions of the plural mecanum wheels 330 because the plural rotation rollers 331 form a predetermined angle with respect to the rotation direction of the cylindrical or circular plate 333 thereof.

As described above, each mecanum wheel 330 may be controlled in accordance with the direction or speed of force sensed by the force sensing unit 110 and/or the direction or speed of motion sensed by the motion sensing unit 120.

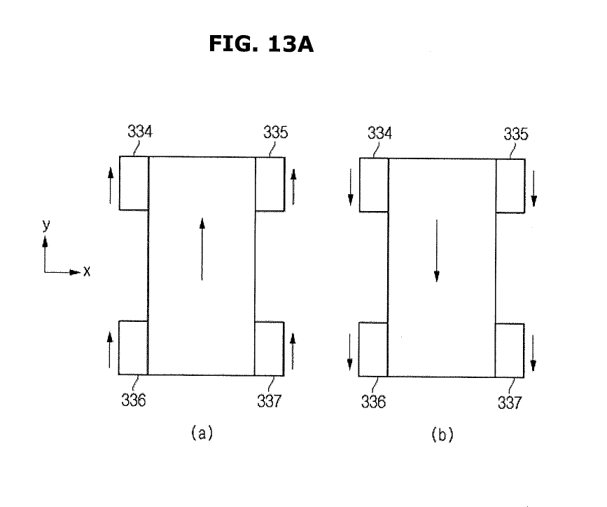

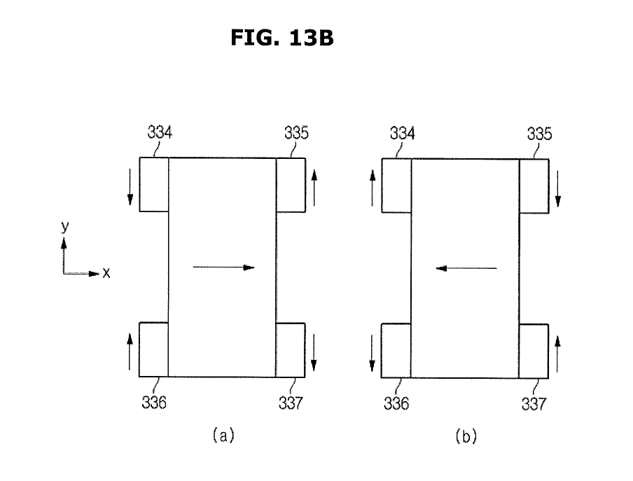

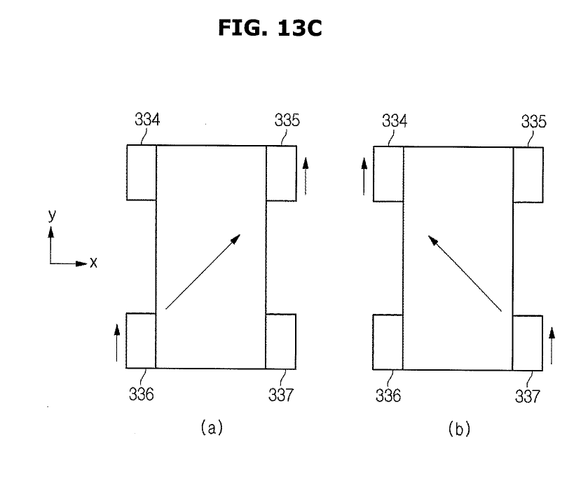

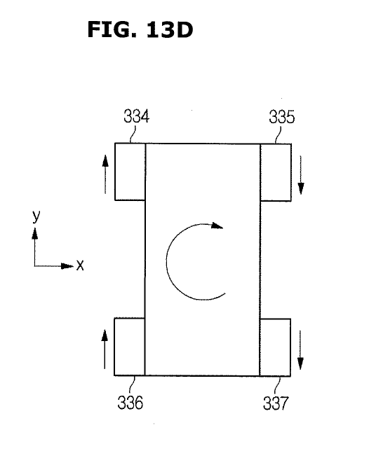

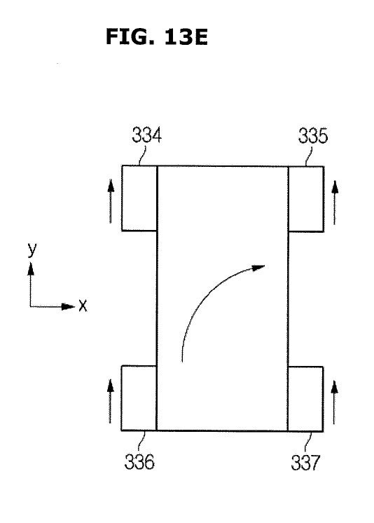

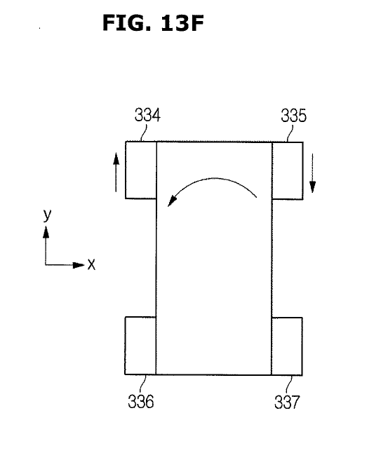

FIGS. 13A to 13F are views illustrating examples of movement control of the movable medical apparatus using the mecanum wheels.

FIGS. 13A to 13F illustrate examples in which four mecanum wheels are installed at opposite sides of the medical apparatus. However, the disclosure is not so limited, as the medical apparatus may include one, two, three, or more than four mecanum wheels according to manufacturing requirements or other considerations such as the terrain or obstacles which may need to be traversed by the medical apparatus.

FIG. 13A shows four mecanum wheels 334 to 337 which are installed at opposite sides of the medical apparatus. For example, the extension directions of the roller members 331a and 331b thereof may be identical or different.

For example, the extension directions of the roller members 331a and 331b in the mecanum wheel 334 installed at a left upper end of the medical apparatus and in the mecanum wheel 337 installed at a right lower end of the medical apparatus may be identical. In addition, the extension directions of the roller members 331a and 331b in the mecanum wheel 335 installed at a right upper end of the medical apparatus and in the mecanum wheel 336 installed at a left lower end of the medical apparatus may be identical. However, the extension directions of the roller members 331a and 331b in the mecanum wheels 334 and 336 or mecanum wheels 335 and 337, which are installed at the same side of the medical apparatus may be different.

In more detail, the mecanum wheels 334 and 337 respectively installed at the left upper and right lower ends of the medical apparatus may have a structure as illustrated in a left portion of FIG. 12. That is, the extension directions a and b of the roller members 331a and 331b installed around the mecanum wheels 334 and 337 may be left upward and right downward directions in FIG. 12, respectively. On the other hand, the mecanum wheels 335 and 336 respectively installed at the right upper and left lower ends of the medical apparatus may have a structure as illustrated in a right portion of FIG. 12. That is, the extension directions a and b of the roller members 331a and 331b installed around the mecanum wheels 335 and 336 may be right upward and left downward directions as shown in FIG. 12, respectively.

In the following description explaining rotation directions of the mecanum wheels 334 to 337 in order to explain movement of the medical apparatus with reference to FIGS. 13A to 13F, it is assumed that the plural mecanum wheels 334 to 337 rotate in the same direction when upper and lower ones of the mecanum wheels 334 to 337 move in the same direction, whereas the mecanum wheels 334 to 337 rotate in different directions when the upper and lower ones of the mecanum wheels 334 to 337 move in different directions.

As illustrated in FIGS. 13A(a) and 13A(b), when the plural mecanum wheels 334 and 337 rotate in the same direction at the same speed, the medical apparatus is moved in a direction corresponding to the rotation direction of the mecanum wheels 334 and 337.

Accordingly, when the user applies force to the force sensing unit 110, for example, in a y-axis direction, as illustrated in FIG. 13A(a), the control unit 200 generates a control signal to rotate the plural mecanum wheels 334 to 337 in the same direction. In accordance with the control signal, the mecanum wheels 334 to 337 are rotated in the same direction. Thus, the medical apparatus may be moved in the y-axis direction. On the other hand, when the user applies force to the force sensing unit 110 in a direction opposite to the y-axis direction, as illustrated in FIG. 13A(b), the mecanum wheels 334 to 337 are rotated in the same direction, but in a direction opposite to that of the above-described case. Thus, the medical apparatus may be moved in the direction opposite to the y-axis direction.

When the user makes a gesture corresponding to movement of the medical apparatus in the y-axis direction, for example, a gesture of upwardly moving one finger, the motion sensing unit 130 may sense the user gesture, and the control unit 200 may then generate a control signal to rotate the plural mecanum wheels 334 to 337 in the same direction. In this case, the mecanum wheels 334 to 337 may be rotated in the same direction in accordance with the control signal.

As illustrated in FIGS. 13B(a) and 13B(b), when the mecanum wheels disposed at the same side (for example, the mecanum wheels 334 and 336) among the plural mecanum wheels 334 to 337 rotate in opposite directions, respectively, and the mecanum wheels disposed to oppose in a diagonal direction (for example, the mecanum wheels 334 and 337) among the plural mecanum wheels 334 to 337 rotate in the same direction, the medical apparatus may be moved in a lateral direction because the rotation rollers 331 of each mecanum wheel 330 form a certain angle with respect to the rotation direction of the mecanum wheel 330. In detail, as illustrated in FIG. 12, when the mecanum wheel 330 rotates in a certain direction, a motion vector is generated in a direction perpendicular to the extension directions a and b of the rotation rollers 331 due to the inclination of the rotation rollers 331. Thus, the mecanum wheel 330 moves in accordance with the generated motion vector.

Accordingly, as illustrated in FIG. 13B(a), motion vectors in rightward and downward directions, namely, x and −y-axis directions, are generated at the mecanum wheels 334 and 337 installed at the left upper and right lower ends of the medical apparatus. Meanwhile, motion vectors in rightward and upward directions, namely, x and y-axis directions, are generated at the mecanum wheels 335 and 336 installed at the right upper and left lower ends of the medical apparatus. As a result, motion vectors in the rightward direction, namely, the x-axis direction, are generated in the medical apparatus and, as such, the medical apparatus is moved to the right.

When the mecanum wheels 334 to 337 rotate in directions opposite to those in the above-described case, as illustrated in FIG. 13B(b), motion vectors in a leftward direction, namely, a −x-axis direction, are generated and, as such, the medical apparatus is moved in the leftward direction.

In an example embodiment, when the user applies force to the force sensing unit 110 in the rightward direction or makes a motion corresponding to movement of the medical apparatus in the rightward direction, the mecanum wheels 334 to 337 operate as illustrated in FIG. 13B(a) and, as such, the medical apparatus may be moved to the right. On the other hand, when the user applies force to the force sensing unit 110 in the leftward direction or makes a motion corresponding to movement of the medical apparatus in the leftward direction, the mecanum wheels 334 to 337 operate as illustrated in FIG. 13B(b) and, as such, the medical apparatus may be moved in the leftward direction.

The medical apparatus may also be moved in a diagonal direction by fixing a part of the plural mecanum wheels 334 to 337, namely, the mecanum wheels 334 and 337, while driving another part of the plural mecanum wheels 334 to 337, namely, the mecanum wheels 335 and 336, as illustrated in FIGS. 13C(a) and 13C(b).

For example, when the right upper mecanum wheel 335 and left lower mecanum wheel 336 are driven, motion vectors in rightward and upward directions, namely, x and y-axis directions, are generated and, as such, the medical apparatus may be moved in a right upward direction. On the other hand, when the left upper mecanum wheel 334 and right lower mecanum wheel 337 are driven, motion vectors in leftward and upward directions, namely, −x and y-axis directions, are generated and, as such, the medical apparatus is moved in a left upward direction.

In an example embodiment, when the user applies force to the force sensing unit 110 in a right upward direction, the mecanum wheels 334 to 337 operate as illustrated in FIG. 13C(a) and, as such, the medical apparatus may be moved in the rightward and upward direction. On the other hand, when the user applies force to the force sensing unit 110 in a left upward direction, the mecanum wheels 334 to 337 operate as illustrated in FIG. 13C(b) and, as such, the medical apparatus may be moved in a left upward direction. The mecanum wheels 334 to 337 may also be operated such that the medical apparatus is moved in a rightward and downward direction and/or a leftward and downward direction.

As illustrated in FIG. 13D, the medical apparatus may be rotated by rotating a part of the mecanum wheels 334 to 337. For example, the mecanum wheels 334 and 336 installed at one side of the medical apparatus, and another part of the mecanum wheels 334 to 337, for example, the mecanum wheels 335 and 337 installed at the other side of the medical apparatus, in different directions.

In an example embodiment, when the user applies a certain rotational moment to the force sensing unit 110 through manipulation of the force sensing unit 110, for example, rotation of the force sensing unit 110, the mecanum wheels 334 to 337 are rotated at a standstill, as illustrated in FIG. 13D.

As illustrated in FIG. 13E, the medical apparatus may be moved along a curved path by increasing the speed of a part of the mecanum wheels 334 to 337, for example, the mecanum wheels 334 and 336, as compared to the remainder of the mecanum wheels 334 to 337, for example, the mecanum wheels 335 and 337.

For example, the medical apparatus may be rotated in a rightward direction along a curved path, as illustrated in FIG. 13E, by rotating the mecanum wheels 334 to 337 such that the rotational speed of the mecanum wheels installed at one side of the medical apparatus, for example, the left upper mecanum wheel 334 and left lower mecanum wheel 336 is higher than that of the mecanum wheels installed at the other side of the medical apparatus, for example, the right upper mecanum wheel 335 and right lower mecanum wheel 337. On the other hand, it may be possible to rotate the medical apparatus in a leftward direction along a curved path by rotating the mecanum wheels 334 to 337 such that the rotational speed of the mecanum wheels installed at one side of the medical apparatus, for example, the left upper mecanum wheel 334 and left lower mecanum wheel 336 is lower than that of the mecanum wheels installed at the other side of the medical apparatus, for example, the right upper mecanum wheel 335 and right lower mecanum wheel 337.

Similarly, the mecanum wheels 334 to 337 may be driven as illustrated in FIG. 13E in accordance with the application direction of force applied to the force sensing unit 110 by the user and, as such, the medical apparatus may be rotated in a rightward or leftward direction.

As illustrated in FIG. 13F, the medical apparatus may be turned by driving a part of the mecanum wheels 334 to 337, for example, the mecanum wheels 334 and 335, while fixing another part of the mecanum wheels 334 to 337, for example, the mecanum wheels 336 and 337. That is, the direction of the medical apparatus may be changed.

For example, the medical apparatus may be turned to the left by rotating the left upper mecanum wheel 334 in the y-axis direction while rotating the right upper mecanum wheel 335 in a direction opposite to the rotation direction of the left upper mecanum wheel 334. On the other hand, the medical apparatus may be turned to the right by rotating the right upper mecanum wheel 335 in the y-axis direction while rotating the left upper mecanum wheel 334 in a direction opposite to the rotation direction of the right upper mecanum wheel 335. Although FIG. 13F illustrates the embodiment in which only the upper mecanum wheels 334 and 335 are driven, it may be possible to change the direction of the medical apparatus by driving only the lower mecanum wheels 336 and 337 while stopping the upper mecanum wheels 334 and 335.

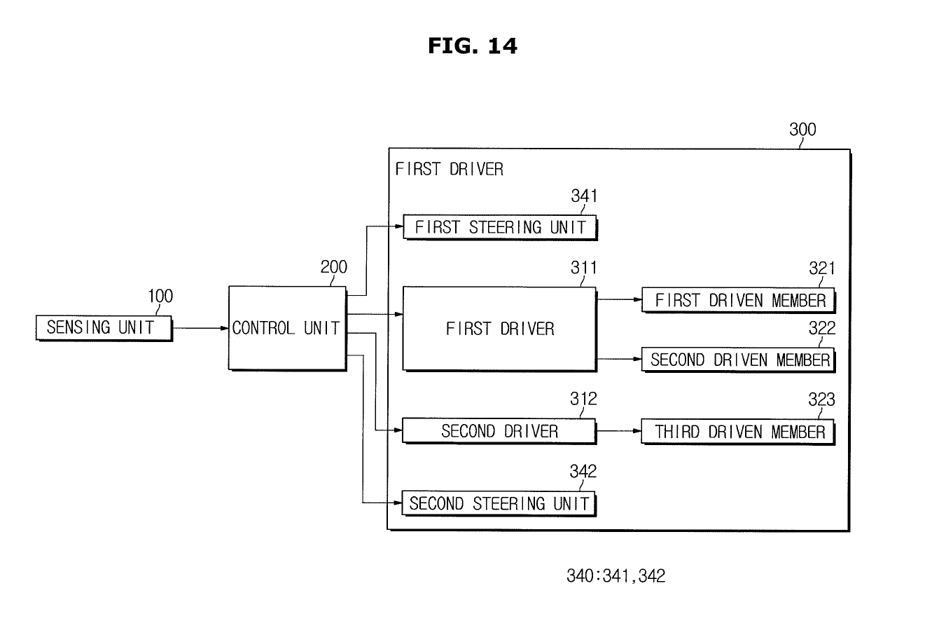

FIG. 14 is a block diagram explaining an example embodiment of the apparatus moving unit of the movable medical apparatus.

As illustrated in FIG. 14, the apparatus moving unit 330 may include drivers 311 and 312, driven members 321 to 323, and a steering unit 340.

The steering unit 340 may adjust the directions of the driven members. For example, the steering unit 340 may steer the driven members 321 to 323.

In an example embodiment, the steering unit 340 may include steering units 341 and 342 respectively associated with the driven members 321 to 323. Each of the steering units 341 and 342 may steer an associated one of the driven members 321 to 323.

Alternatively, the steering unit 340 may steer plural driven members. For example, the steering unit 340 may steer the first driven member 321 and second driven member 322, or may steer only one driven member, for example, the second driven member 323. When the steering unit 340 may include the plural steering units 341 and 342, a part of the steering units 341 and 342, for example, the steering unit 341, may steer a part of the plural driven members 321 to 323, for example, the driven members 321 and 322, and another part of the steering units 341 and 342, for example, the steering unit 342, may steer another part of the driven members 321 to 323, for example, the driven member 323. By way of example, steering unit 341 may steer driven members 321 and 322, while steering unit 342 may steer driven member 323.

In an example embodiment, the steering units 341 and 342 may also drive the drivers 311 and 312, which drive the driven members 321 to 323, in addition to steering of the driven members 321 to 323.

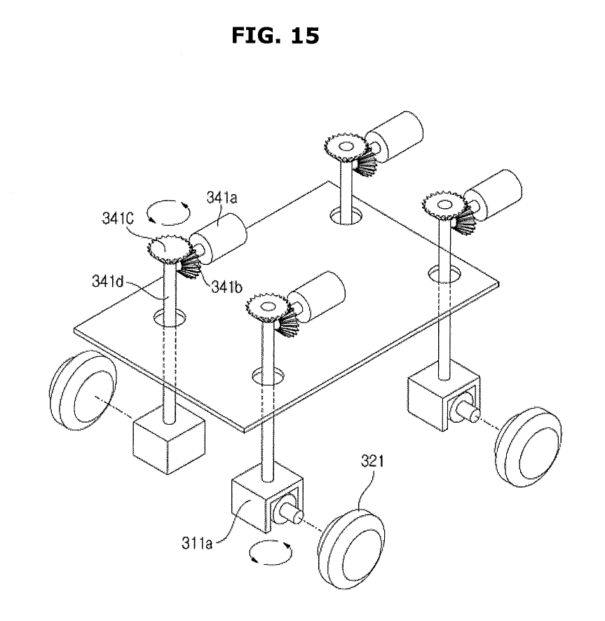

FIG. 15 is a view explaining an example of the steering unit included in the apparatus moving unit.

In detail, the steering unit 340 may include steering drivers 341a and rotating shaft members 341d.

Each steering driver 341a may be driven in accordance with a control signal transmitted from the control unit 200, thereby rotating an associated one of the rotating shaft members 341d. Each rotating shaft member 341d may be coupled, at one end thereof, with an associated one of the driven members 321 to 323 or an associated one of the drivers 311 and 312. When the rotating shaft member 341d is rotated in accordance with operation of the associated steering driver 341a, the driven member coupled to the rotating shaft member 341d, for example, the driven member 321, may be horizontally rotated and, as such, may be steered. In this case, the driver 311 associated with the driven member 321 may also be horizontally rotated.

In an embodiment, as illustrated in FIG. 15, each steering driver 341a may rotate the associated rotating shaft member 341d via bevel gears 341b and 341c. For example, the bevel gear 341b may be coupled, as a pinion gear, to the steering driver 341a. The rotation axis of the pinion gear 341b may be coaxial with the rotation axis of the steering driver. In order to rotate the bevel gear 341c as a ring gear, the pinion gear 341b may engage with the ring gear 341c by teeth. The ring gear 341c may be coupled to one end of the rotating shaft member 341d. The rotation axis of the rotating shaft member 341d may be coaxial with the rotation axis of the ring gear 341c. For example, the rotating shaft member 341d may rotate in clockwise and/or counterclockwise directions.

Meanwhile, a housing 311a may be coupled to the other end of each rotating shaft member 341d. The housing 311a accommodates an associated one of the drivers, for example, the driver 311, to stably hold the driver 311.

The control unit 200 may generate control signals for all the steering drivers 341a and drivers 311 and 312. Alternatively, the control unit 200 may generate control signals only for the steering drivers 341a or only for the drivers 311 and 312. Generally, the control unit 200 may generate control signals only for one or more of the steering drivers, the control unit 200 may generate control signals only for one or more of the drivers, or the control unit 200 may generate control signals for one or more of the steering drivers and for one or more of the drivers.

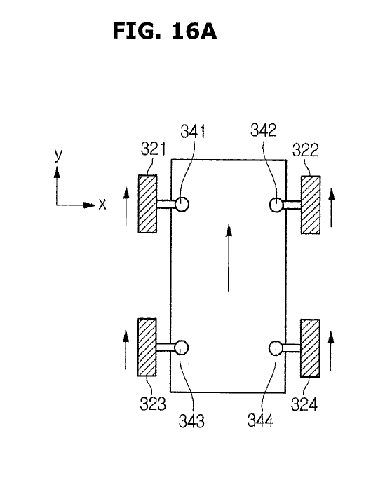

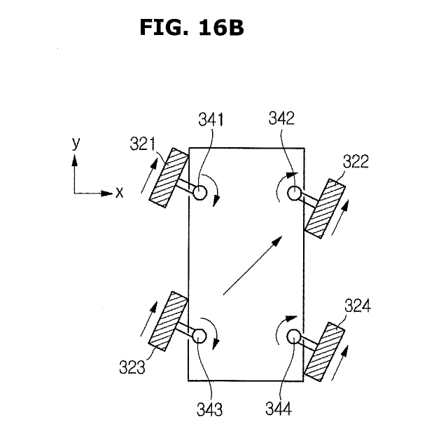

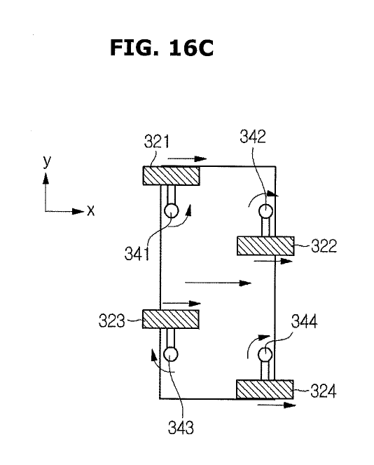

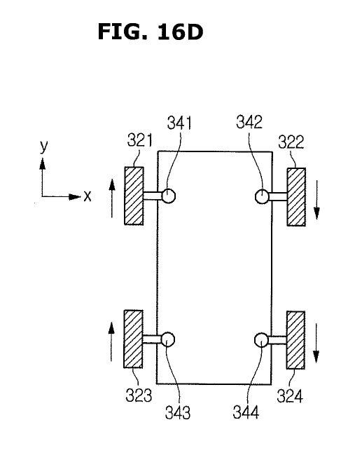

FIGS. 16A to 16D are views illustrating control of movement of the movable medical apparatus, which includes driven members 321 to 324, and steering units 341 to 344.

When the user applies a force to the force sensing unit 110 in a y-axis direction or makes a gesture corresponding to a movement of the medical apparatus in the y-axis direction, the control unit 200 may control the steering units 341 to 344, to rotate all the driven members 321 to 324 in the same direction, as illustrated in FIG. 16A, in accordance with the direction of the applied force or the observed or received gesture. The steering units 341 to 344 may rotate the rotating shaft members 341d under the control of the control unit 200, to cause all the driven members 321 to 324 to be in parallel in the y-axis direction.

When the user applies a force to the force sensing unit 110 in a right upward direction (x, y) or makes a gesture corresponding to movement of the medical apparatus in the right upward direction (x, y), the control unit 200 may generate a control signal, and may transmit the control signal to each of the steering units 341 to 344, to horizontally rotate the driven members 321 to 324 to be directed in a right upward direction, as illustrated in FIG. 16B. Each of the steering units 341 to 344 may receive the control signal from the control unit 200, and may rotate the associated rotating shaft member 341d in accordance with the received control signal. For example, each of the steering units 341 to 344 may rotate the associated rotating shaft member 341d in a clockwise direction. As a result, all driven members 321 to 324 may be horizontally rotated to be directed in the right upward direction and, as such, the medical apparatus may move in the right upward direction in accordance with the horizontal rotation direction of the driven members 321 to 324.

When the user applies a force to the force sensing unit 110 in a rightward direction, namely, an x-axis direction or makes a gesture corresponding to movement of the medical apparatus in the rightward direction, the control unit 200 may generate a control signal for the steering units 341 to 344, to horizontally rotate all the driven members 321 to 324 to be directed in the rightward direction, as illustrated in FIG. 16C. In accordance with the control signal from the control unit 200, each of the steering units 341 to 344 may further rotate the associated rotating shaft member 341d in a clockwise direction. As a result, all driven members 321 to 324 may be horizontally rotated to be directed in the rightward direction and, as such, the medical apparatus may move in the rightward direction in accordance with the horizontal rotation direction of the driven members 321 to 324.

When the user applies a certain rotational moment to the force sensing unit 110 or makes a gesture corresponding to rotation of the medical apparatus, the control unit 200 may generate control signals to control directions of the driven members 321 to 324 to cause the driven members 321 to 324 to be parallel, and control signals to rotate the driven members 321 and 323 or driven members 322 and 324 disposed at the same side of the medical apparatus in the same direction, as illustrated in FIG. 16D, in accordance with the rotational moment or gesture. In this case, the control signals for controlling directions of the driven members 321 to 324 may be transmitted to respective steering units 341 to 344, and the control signals for controlling rotation directions of the driven members 321 to 324 may be transmitted to the drivers 311 to 314, respectively. Each of the steering units 341 to 344 may receive an associated one of the control signals from the control unit 200, and rotate the associated rotating shaft member 341d, thereby causing the driven members 321 to 324 to be parallel, as illustrated in FIG. 16D. The drivers 311 to 314 rotate the driven members 321 to 324 in desired directions, simultaneously with or after driving of the steering units 341 to 344. Thus, the medical apparatus is rotated in accordance with driving of the driven members 321 to 324.

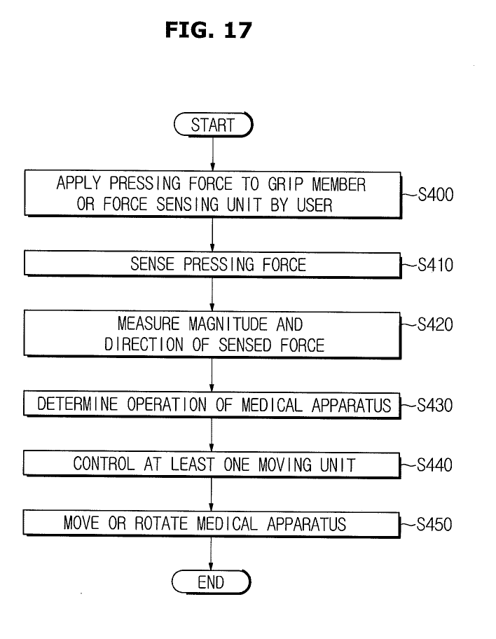

FIG. 17 is a flowchart illustrating an example embodiment of a method for controlling movement of the movable medical apparatus.

In accordance with an example embodiment of the method, which controls the movable medical apparatus, the user applies a force or moment to the grip member or force sensing unit (S400). In this case, the grip member may transmit the force applied by the user to the force sensing unit because the grip member is directly installed at the force sensing unit. The grip member may transmit force applied by the user to the force sensing unit via a separate force transmitter.

The force sensing unit may sense the force or moment applied thereto (S410), and may measure the direction of the sensed force and/or the magnitude of the applied moment to output an electrical signal corresponding to results of the measurement (S420).

In response to the electrical signal, an operation of the medical apparatus may be determined (S430). Operation of the medical apparatus may be determined in accordance with the magnitude and/or direction of the sensed force and/or the magnitude or rotation direction of the sensed moment. Thereafter, a control signal for execution of the determined operation of the medical apparatus may be generated.

In accordance with the control signal for execution of the determined operation of the medical apparatus, at least one moving unit may be controlled (S440). The moving unit may include drivers and driven members. In accordance with an example embodiment, the moving unit may further include steering units. The driven members may be a drive wheel. For example, each driven member may be a mecanum wheel.

In accordance with operation of the driven members, the medical apparatus may be moved or rotated in accordance with the magnitude and/or direction of the sensed force and/or the magnitude or rotation direction of the sensed moment (S450). For example, the driven members may operate after the steering units adjust the direction of the associated driven members. Accordingly, the medical apparatus may be moved in multiple directions. On the other hand, when each driven member is a mecanum wheel, the medical apparatus may be moved in multiple directions in accordance with a rotational speed and rotation direction of each driven member.

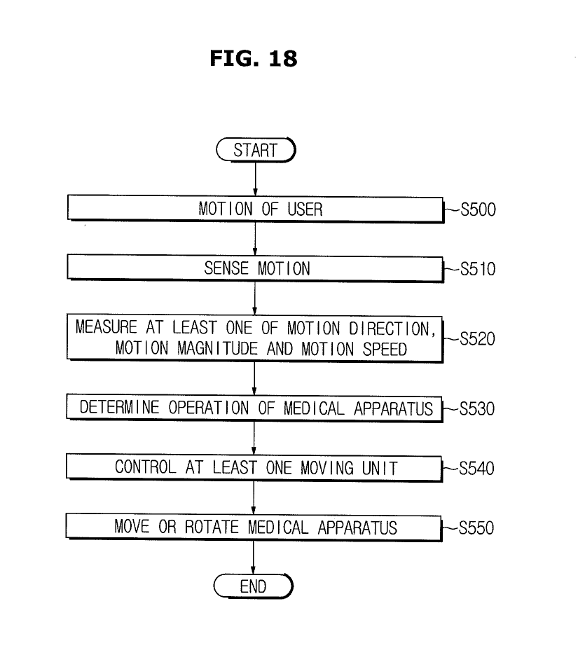

FIG. 18 is a flowchart illustrating an example embodiment of the method for controlling movement of the movable medical apparatus.

When the user or an object makes a certain motion (S500), the motion sensing unit senses the motion of the user or object, using a motion sensing medium such as visible light, infrared light, ultrasonic waves, or electromagnetic waves, and outputs an electrical signal corresponding to the sensed motion (S510). For example, the motion sensing unit may sense motion of the user or object through a combination of a plurality of motion sensing mediums.

Thereafter, the motion sensing unit may measure at least one of the direction, magnitude and speed of the motion, based on the electrical signal corresponding to the sensed motion, for example, an image signal (S520).

In accordance with the measured direction, magnitude and speed of the motion, operation of the medical apparatus may be determined (S530). In this case, a control signal according to the determined operation of the medical apparatus may be generated.

In accordance with the control signal corresponding to the determined operation of the medical apparatus, the at least one moving unit may be controlled (S540). As described above, the moving unit may include drivers and driven members. In an example embodiment, the moving unit may further include steering units. The driven members may be a drive wheel. For example, each driven member may be a mecanum wheel.

In accordance with an operation of the driven members, the medical apparatus may be moved or rotated in accordance with the magnitude and/or direction of the sensed force and/or the magnitude or rotation direction of the sensed moment (S550). When each driven member is a mecanum wheel, the medical apparatus may be moved in a desired direction at a desired speed. For example, the medical apparatus may be moved at a speed which corresponds to a sensed speed of the object or user's sensed movement. When the medical apparatus further includes steering units, the medical apparatus may be moved in a desired direction at a desired speed because the direction of each driven member may be adjusted by the associated steering unit.

As is apparent from the above description, it may be possible to achieve an enhancement in mobility of the movable medical apparatus in accordance with the above-described example embodiments of the movable medical apparatus and the above-described control methods disclosed herein.

In accordance with the movable medical apparatus and the control methods described with respect to the example embodiments disclosed herein, it may be possible to move the medical apparatus in multiple directions in accordance with a user's intention.

In accordance with the movable medical apparatus and the control methods described with respect to the example embodiments disclosed herein, it may be possible to eliminate inconvenience occurring during lateral movement of the medical apparatus carried out only through forward and backward driving or rotation.

In accordance with the movable medical apparatus and the control methods described with respect to the example embodiments disclosed herein, it may be possible to improve convenience of positioning upon radiation imaging or using a surgical robot.

In accordance with the movable medical apparatus and the control methods described with respect to the example embodiments disclosed herein, it may be possible to control movement of the movable medical apparatus through an external force applied to the movable medical apparatus, or through a motion of an external object (e.g., gestures of a user). However, other methods to provide a command may be implemented. For example, voice commands may also be provided and the movable medical apparatus may perform voice recognition to generate control signals to move or stop the medical apparatus. Additionally, or alternatively, another input device may be utilized, including a touch pad, touch screen, keyboard, joystick, remote controller, smartphone, tablet, and the like. The input device may be connected to the movable medical apparatus over a wired connection, a wireless connection or a combination thereof.

The movable medical apparatus and methods according to the above-described example embodiments may use one or more processors. For example, a processing device may be implemented using one or more general-purpose or special purpose computers, such as, for example, a processor, an image processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Some example embodiments of the present disclosure can also be embodied as a computer readable medium including computer readable code/instruction to control at least one component of the above-described example embodiments. The medium may be any medium that can storage and/or transmission the computer readable code.

Aspects of the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA). Some or all of the operations performed according to the above-described example embodiments may be performed over a wired or wireless network, or a combination thereof.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. Also, while an illustration may show an example of the direction of flow of information for a process, the direction of flow of information may also be performed in the opposite direction for a same process or for a different process.

Although example embodiments disclosed herein have been shown and described, it would be appreciated by those skilled in the art that changes may be made to these example embodiments without departing from the principles and spirit of the invention, the scope of which is defined in the claims and their equivalents.

What is claimed is:

1. A movable medical apparatus comprising:
a force sensing unit to sense a force externally applied to the movable medical apparatus;
a control unit to generate one or more control signals to move, rotate, or stop the movable medical apparatus based on the sensed force; and
an apparatus moving unit to move, rotate, or stop the movable medical apparatus based on the one or more control signals.

2. The movable medical apparatus according to claim 1, wherein the apparatus moving unit comprises:
a plurality of driven members; and
one or more drivers to drive one or more of the plural driven members based on the one or more control signals to move, rotate, or stop the movable medical apparatus.

3. The movable medical apparatus according to claim 2, wherein the control unit generates one or more control signals for the one or more drivers, respectively, based on the sensed force.

4. The movable medical apparatus according to claim 3, wherein the one or more drivers drive or stop the one or more driven members connected to the one or more drivers based on the one or more control signals for the one or more drivers, respectively.

5. The movable medical apparatus according to claim 2, wherein the one or more control signals comprise a control signal for at least one of a rotation direction of each of the plurality of driven members and a rotational speed of each of the plurality of driven members.

6. The movable medical apparatus according to claim 2, wherein the apparatus moving unit comprises a plurality of drivers and each of the drivers drives one or more of the driven members.

7. The movable medical apparatus according to claim 2, wherein each of the driven members comprises a mecanum wheel formed with a plurality of rotation rollers at an outer circumferential surface of the mecanum wheel.

8. The movable medical apparatus according to claim 1, wherein the apparatus moving unit comprises:
a plurality of driven members;
one or more drivers to drive one or more of the plurality of driven members based on the one or more control signals; and
a steering unit to steer the plurality of driven members.

9. The movable medical apparatus according to claim 8, wherein the steering unit comprises:
at least one rotation shaft member coupled, at one end thereof, with an associated one of the driven members or an associated one of the drivers; and
at least one steering driver to rotate the at least one rotation shaft member based on the one or more control signals.

10. The movable medical apparatus according to claim 9, wherein the control unit generates control signals for the drivers or the at least one steering driver based on the externally applied force.

11. The movable medical apparatus according to claim 1, further comprising:
a grip member to transmit the externally applied force to the force sensing unit.

12. The movable medical apparatus according to claim 11, further comprising:
a force transmitter to transmit, to the force sensing unit, the force applied to the grip member.

13. The movable medical apparatus according to claim 1, wherein the force sensing unit includes:
a pressing member to receive the applied external force;
a measuring member coupled to the pressing member to measure at least one of a magnitude and a direction of the applied external force, and to output an electrical signal based on the measured magnitude and direction of the applied external force; and
an amplifier to selectively amplify the electric signal.

14. The movable medical apparatus according to claim 1, further comprising:
a motion sensing unit to sense an external motion of an object; and
wherein the control unit further generates one or more control signals to move, rotate, or stop the movable medical apparatus based on the sensed motion.

15. A movable medical apparatus comprising:
a motion sensing unit to sense an external motion of an object;
a control unit to generate one or more control signals to move, rotate, or stop the movable medical apparatus based on the sensed motion; and
an apparatus moving unit to move, rotate, or stop the movable medical apparatus based on the one or more control signals.

16. The movable medical apparatus according to claim 15, wherein the motion sensing unit senses the external motion using at least one of infrared light, ultrasonic waves, electromagnetic waves, and visible light.

17. The movable medical apparatus according to claim 15, wherein the motion sensing unit senses the motion of the object by receiving light reflected from the object or by emitting ultrasonic waves or electromagnetic waves toward the object and receiving ultrasonic waves or electromagnetic waves reflected from the object, and outputs an electrical signal corresponding to the received light, ultrasonic waves, or electromagnetic waves,
and the medical apparatus further comprises a motion determiner to determine at least one of a magnitude, direction, and speed of the motion of the object based on the electrical signal.

18. The movable medical apparatus according to claim 15, further comprising: a force sensing unit to sense a force externally applied to the movable medical apparatus; and
wherein the control unit further generates one or more control signals to move, rotate, or stop the movable medical apparatus based on the sensed force.

19. A method for controlling movement of a movable medical apparatus, comprising:
sensing a force externally applied to the movable medical apparatus or motion of an object;
measuring at least one of a magnitude of the sensed force and a direction of the sensed force or at least one of a direction of the sensed motion, a magnitude of the sensed motion, and a speed of the sensed motion;
determining an operation of the movable medical apparatus based on at least one of the measured force magnitude and direction or at least one of a direction of the sensed motion, a magnitude of the sensed motion, and a speed of the sensed motion; and
controlling a moving unit based on the determined operation of the movable medical apparatus, to move or rotate the movable medical apparatus.

20. A medical apparatus comprising:
a body including a rotating member attached to the body;
a first sensing unit to sense an external force applied to the medical apparatus;
a second sensing unit to sense a motion of an object disposed external to the medical apparatus;
a controller to determine an operation of the medical apparatus based on at least one of a sensed external force and a sensed motion of an object disposed external to the medical apparatus; and
an apparatus moving unit to move the medical apparatus based on the determined operation.
